(19) United States
(12) Patent Application Publication
(10) Pub. No.: US 2026/0217143 A1
(43) Pub. Date: Jul. 30, 2026

(54) VEHICLE CHARGE DEVICE AND VEHICLE CHARGE SYSTEM

(71) Applicant: ASTEMO, LTD., Chiyoda-ku, Tokyo (JP)

(72) Inventors: Hiroaki TAKUMA, Hitachinaka-shi, Ibaraki (JP); Hideki MIYAZAKI, Hitachinaka-shi, Ibaraki (JP); Toshiyuki INNAMI, Hitachinaka-shi, Ibaraki (JP); Yoshihito YASUKAWA, Hitachinaka-shi, Ibaraki (JP)

(73) Assignee: ASTEMO, LTD., Chiyoda-ku, Tokyo (JP)

(21) Appl. No.: 19/143,658

(22) PCT Filed: Dec. 27, 2022
(86) PCT No.: PCT/JP2022/048378

§ 371 Date: Jun. 26, 2025

(51) Int. Cl. B60L 53/20; B60L 53/10; B60L 53/62; B60L 53/66; H02J 7/34; H02J 7/80; H02M 3/335; H02M 7/219

(52) U.S. Cl. CPC B60L 53/20; B60L 53/11; B60L 53/62; B60L 53/66; H02J 7/342; H02J 7/80; H02M 3/33573; H02M 3/33584; H02M 7/219; B60L 2210/30; H02J 2207/20

(57) ABSTRACT

A vehicle charge device and a vehicle charge system include: a power converter that is connected to an AC power supply outside the first vehicle and converts AC power input from the AC power supply into first DC power; a voltage converter that transforms an input DC voltage into a charging voltage of the first battery; a voltage conversion control unit that controls the voltage converter; and a DC input terminal connected to a DC power supply outside the first vehicle, in which the DC input terminal inputs a DC voltage of second DC power input from the DC power supply to the voltage converter, and in which the voltage converter transforms the DC voltage of at least one of the first DC power or the second DC power into the charging voltage of the first battery according to an instruction from the voltage conversion control unit.

### TECHNICAL FIELD

The present invention relates to a vehicle charge device and a vehicle charge system.

### BACKGROUND ART

With the increase in the spread of electric vehicles, there is also a possibility that a problem that a vehicle becomes unable to travel due to falling into an electricity shortage state increases. Therefore, as a method of charging the vehicle at a place other than the power feeding place, wireless power feeding on a road, battery charging between vehicles, and the like are also considered as one of the power feeding methods. This is a method of charging an own vehicle battery by converting a voltage input from another vehicle or an external power supply by an output conversion unit and a voltage conversion unit of an on-board charger (OBC) mounted on a vehicle. In such a charging method, a charging facility that enables stable charging is important, and for example, PTL 1 discloses a configuration of a charging device that realizes stable charging by a power conversion unit controlling a DC voltage and a frequency of the voltage conversion unit being constant during the control.

### CITATION LIST

### Patent Literature

PTL 1: JP 2021-93788 A

### SUMMARY OF INVENTION

### Technical Problem

In conventional inter-vehicle charging, there is a problem that charging itself becomes impossible due to a short circuit when power supply and charging are performed between batteries having a voltage difference. The present invention has been made in view of the above circumstances, and an object of the present invention is to provide a vehicle charge device and a vehicle charge system that. realize battery charging from power supplies with different voltages in inter-vehicle charging.

### Solution to Problem

A vehicle charge device and a vehicle charge system that charge a first battery mounted on a first vehicle, the vehicle charge device and the vehicle charge system includes: a power converter that is connected to an AC power supply outside the first vehicle and converts AC power input from the AC power supply into first DC power; a voltage converter that transforms an input DC voltage into a charging voltage of the first battery; a voltage conversion control unit that controls the voltage converter; and a DC input terminal connected to a DC power supply outside the first vehicle, in which the DC input terminal inputs a DC voltage of second DC power input from the DC power supply to the voltage converter, and in which the voltage converter transforms the DC voltage of at least one of the first DC power or the second DC power into a charging voltage of the first battery according to an instruction from the voltage conversion control unit.

### Advantageous Effects of Invention

It is possible to provide a vehicle charge device and a vehicle charge system that realize battery charging from DC power supplies with different voltages in inter-vehicle charging.

### BRIEF DESCRIPTION OF DRAWINGS

FIG. 1 is an explanatory diagram of a vehicle charge device according to an embodiment of the present invention.

FIG. 2 is an electric circuit diagram of the vehicle charge device according to the embodiment of the present invention.

FIG. 3 is a first modification.

FIG. 4 is a second modification.

FIG. 5 is a third modification.

FIG. 6 is a flowchart of a control unit of the vehicle charge device according to the embodiment of the present invention.

### DESCRIPTION OF EMBODIMENTS

Hereinafter, embodiments of the present invention will be described with reference to the drawings. The following description and drawings are examples for describing the present invention, and are omitted and simplified as appropriate for the sake of clarity of description. The present invention can be carried out in various other forms. Unless otherwise specified, each component may be singular or plural.

Positions, sizes, shapes, ranges, and the like of the components illustrated in the drawings may not represent actual positions, sizes, shapes, ranges, and the like in order to facilitate understanding of the invention. Therefore, the present invention is not necessarily limited to the positions, sizes, shapes, ranges, and the like disclosed in the drawings.

### One Embodiment and Overall Configuration of the Present Invention

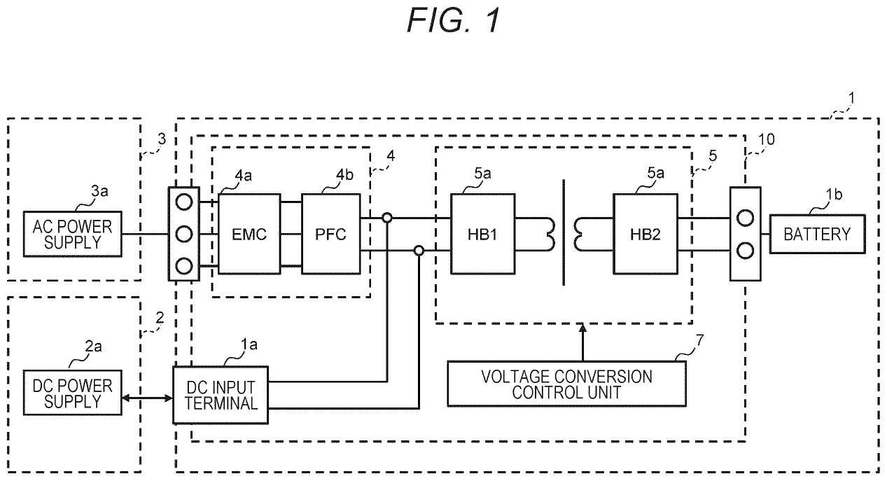

### (FIG. 1)

As an embodiment of a vehicle adopting the present invention, an own vehicle 1 includes a battery 1b and a vehicle charge device 10. The vehicle charge device 10 is, for example, a charging device that performs charging by being connected to the vehicle 1 and a charger 3 outside the vehicle 1. In addition, the vehicle charge device 10 is, for example, a charging device that connects the vehicle 1 and the other vehicle 2 and is capable of bidirectionally charging between batteries mounted on the vehicles.

The vehicle charge device 10 includes a power converter 4 that is connected to an AC power supply 3a of an AC charger 3 outside the own vehicle 1 and converts AC power input from the AC power supply 3a into DC power, a voltage converter 5 that transforms an input DC voltage into a charging voltage of the battery 1b, and a voltage conversion control unit 7 that controls the voltage converter 5. In addition, the vehicle charge device 10 includes a DC input terminal 1a connected to a DC power supply 2a outside the own vehicle 1. Note that the AC power supply 3a is, for example, a commercial AC power supply. The DC power supply 2a outputs a variable voltage or a constant DC voltage.

In the power converter 4, the AC power is rectified and smoothed by an EMC filter 4a, and a power factor correction (PFC) block 4b improves the power factor and suppresses harmonics.

Hereinafter, DC power obtained by converting AC power input from the AC power supply 3a by the power converter 4 is referred to as first DC power, and DC power input from the DC input terminal 1a is referred to as second DC power. The DC input terminal 1a inputs the DC voltage of the second DC power input from the DC power supply 2a to the voltage converter 5. The voltage converter 5 transforms the DC voltage of at least one of the first DC power or the second DC power into the charging voltage of the first battery 1b according to an instruction from the voltage conversion control unit 7.

The voltage conversion control unit 7 grasps information on the charging voltage of the battery 1b, reflects the control content for transforming into the charging voltage of the battery 1b when converting the DC voltage of the second DC power input from the DC input terminal 1a to the voltage converter 5 into the AC voltage by a H-bridge converter 5a, and reconverts the transformed AC voltage into the DC voltage by a H-bridge converter 5b, thereby realizing the charging of the battery 1b.

With such a configuration, the vehicle charge device 10 can charge the battery 1b with power supplied from a commercial power supply (AC power supply 3a) during normal charging, and can cause the voltage converter 5 to convert the voltage into the charging voltage of the battery 1b even when a DC voltage having a voltage different from that of the battery 1b is input during inter-vehicle charging or the like. Note that a plurality of other vehicles 2 and a plurality of DC power supplies 2a may be connected to the vehicle 1.

In addition, the vehicle charge device 10 is configured to be able to input DC power from the DC input terminal 1a to the HB circuit of the voltage converter 5, thereby being able to discharge the DC power from the battery 1b to the DC power supply 2a. The other vehicle 2 can input and output the second DC power between the own vehicle 1 and the other vehicle 2 by mounting the DC power supply 2a and a vehicle charge device (not illustrated) so as to have the same configuration as that of the own vehicle 1 when bidirectional charging is performed.

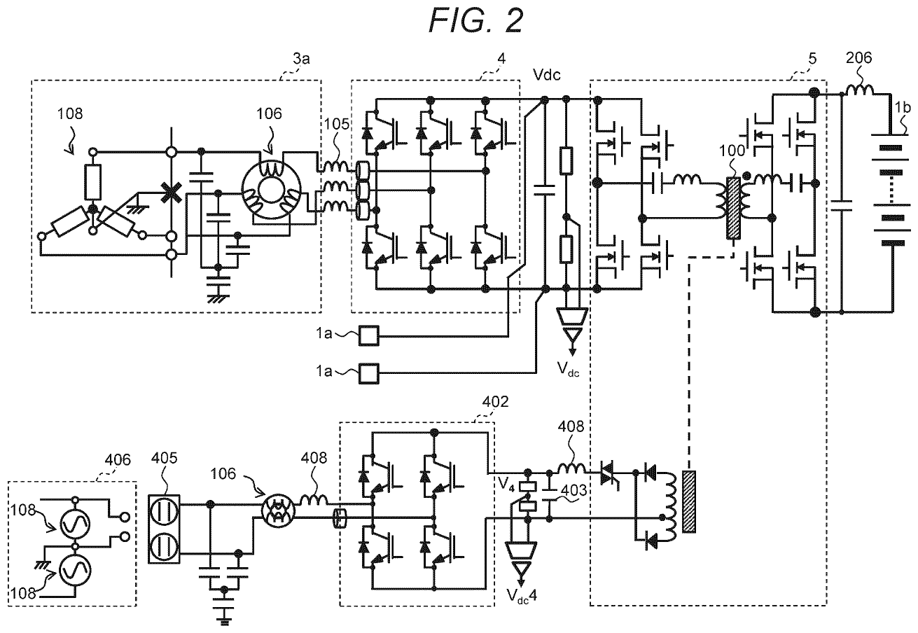

### (FIG. 2)

The AC power supply 3a includes, for example, a grounded three-phase four-wire type commercial AC power supply 108, a common mode choke coil 106, and the like. The AC power supply 3a is connected to the power converter 4 via a choke coil 105. The voltage converter 5 is made of, for example, a silicon carbide metal-oxide semiconductor field-effect transistor (SiC-MOSFET), and includes an insulating transformer 100.

The vehicle 1 can be transformed by being connected to an AC power supply other than the AC power supply 3a, and for example, the battery 1b can be charged by being connected to a single-wire three-phase AC load 406 or the like via the voltage converter 5. The AC load 406 includes, for example, a plurality of commercial AC power supplies 108, and is connected to the own vehicle 1 via a vehicle power supply socket 405. In the AC power input from the vehicle power supply socket 405, the AC power is converted into the DC power by a power converter 402 via the common mode choke coil 106 and a choke coil 408. The DC power converted from the AC power by the power converter 402 is transformed into the charging voltage of the battery 1b by the voltage converter 5 via the capacitor 403, the choke coil 408, and the like.

The DC input terminal 1a is connected to a wiring between the power converter 4 and the voltage converter 5. The DC input terminal 1a is connected to a DC power supply (not illustrated). As a result, either the first DC power converted from the AC power by the power converter 4 or the second DC power input from the DC input terminal 1a is input to the voltage converter 5.

### First Modification

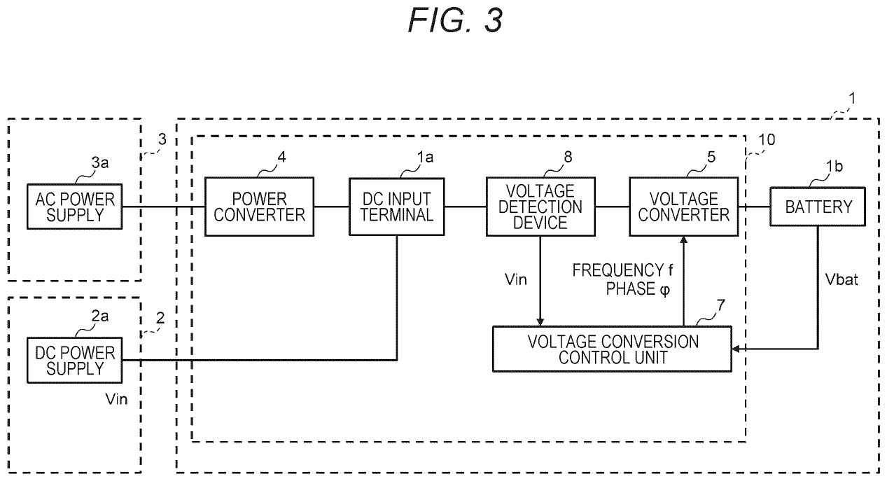

### (FIG. 3)

The vehicle charge device 10 includes a voltage detection device 8 between the DC input terminal 1a and the voltage converter 5. In addition, the voltage conversion control unit 7 that acquires information detected by the voltage detection device 8 and information on the battery 1b and functions as control means of the voltage converter 5 is included.

The voltage detection device 8 detects a DC voltage of the first DC power or the second DC power input to the voltage converter 5, and transmits information on the detected DC voltage to the voltage conversion control unit 7. On the basis of the difference between the DC voltage detected by the voltage detection device 8 and the charging voltage of the battery 1b, the voltage conversion control unit 7 controls at least one of the frequency or the phase of the AC voltage converted in the process of transforming the input DC voltage into the charging voltage of the first battery 1b in the voltage converter 5.

Specifically, the control of the frequency in the voltage converter 5 will be described. For example, when the value of the DC voltage (the battery 2a of the other vehicle 2) detected by the voltage detection device 8 for the DC voltage input from the DC power supply 2a is 800 V and the charging voltage of the battery 1b is 400 V, which are voltage systems different from each other, the voltage conversion control unit 7 performs conversion control on the resonance frequency of the AC voltage converted in the process of transforming the input DC voltage of 800 V in the voltage converter 5 in a state where the resonance frequency is higher than the resonance frequency of the charging voltage of 400 V. In this way, the battery 1b of the own vehicle 1 can be charged even if there is a voltage difference.

On the other hand, when the DC voltage input from the DC power supply 2a is in the same voltage system in which the value of the DC voltage detected by the voltage detection device 8 is 400 V and the charging voltage of the battery 1b is 400 V, for example, the voltage conversion control unit 7 controls the frequency so that the resonance frequency of the AC voltage obtained by converting the input DC voltage of 400 V in the voltage converter 5 approaches the resonance frequency of the AC voltage for setting the charging voltage to 400 V. In this way, inter-vehicle charging can be realized.

Note that a configuration for preventing a failure may be added by providing, for example, a protrusion prevention circuit between the DC input terminal 1a and the voltage detection device 8 to enable control of an inrush current. This not only enables charging with different voltages but also enables a stable state of charge.

### Second modification

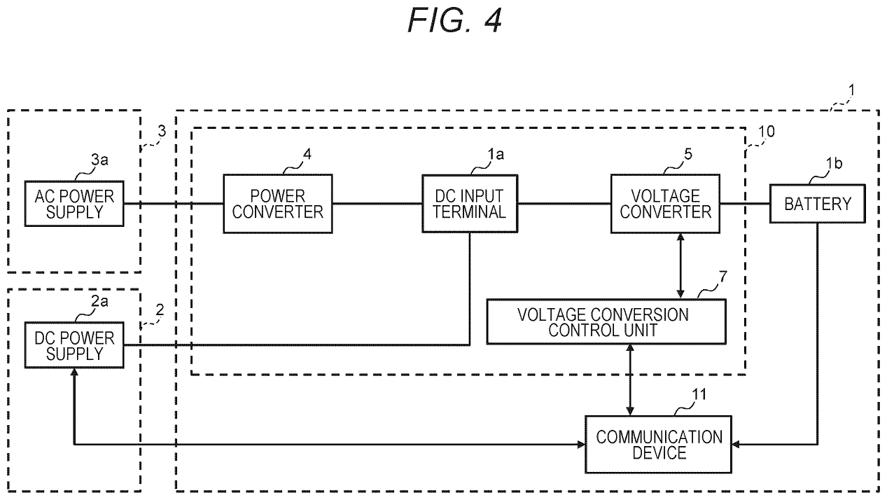

### (FIG. 4)

In addition to the vehicle charge device 10, the own vehicle 1 includes a communication device 11 that transmits and receives information on the charging voltage of the battery 1b to and from a second vehicle 2 different from the own vehicle 1. The communication device 11 transmits and receives information on the charging voltage of the battery 1b and information on the DC voltage that the voltage converter 5 can transform into the charging voltage of the first battery 1b. Note that the charging voltage of the battery 1b is measured by a battery voltage measuring sensor (not illustrated).

The communication device 11 acquires information on the charging voltage of the battery acquired from the sensor and information on the transformation voltage of the voltage converter 5. In addition, the communication device 11 acquires information on the discharge voltage of the DC power supply 2a of the other vehicle 2 via a communication device (not illustrated) mounted on the other vehicle 2 and a sensor (not illustrated) that measures the voltage of the DC power supply 2a. In the own vehicle 1, the information received from the other vehicle 2 is used as information for performing control such that the voltage converter 5 can transform the voltage into the charging voltage of the battery 1b in the vehicle charge device 10.

In this way, the communication devices included in the own vehicle 1 and the other vehicle 2 can transmit and receive each piece of information of the acquired voltage by bidirectional wireless communication. Then, the other vehicle 2 including a battery capable of discharging a voltage close to the charging voltage of the battery 1b of the own vehicle 1 can be selected from the plurality of other vehicles 2, and inter-vehicle charging can be realized even when there is a voltage difference.

### Third modification

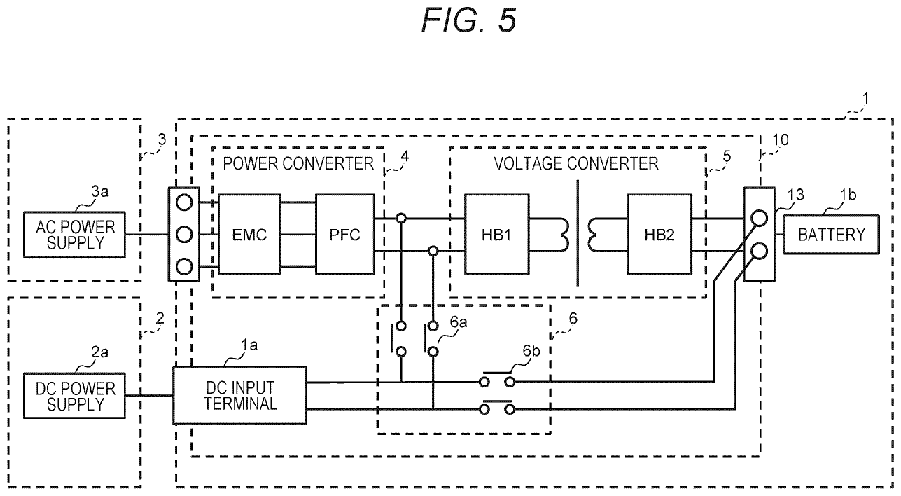

### (FIG. 5)

A rapid charging input terminal 13 for connection with the DC input terminal 1a is provided between the first battery 1b and the voltage converter 5. Correspondingly, the DC input terminal 1a is an input terminal for rapid charging capable of directly inputting the second DC power to the first battery 1b.

A relay circuit 6 including a first switch 6a that connects or disconnects the DC input terminal 1a and the voltage converter 5 and a second switch 6b that connects or disconnects the DC input terminal 1a and the rapid charging input terminal 13 is provided between the rapid charging input terminal 13 and the DC input terminal 1a and between the voltage converter 5 and the DC input terminal 1a. The relay circuit 6 switches the first switch 6a and the second switch 6b when the DC voltage of the second DC power is the same as the charging voltage of the first battery 1b. Note that the DC input terminal 1a and the rapid charging input terminal 12a are, for example, CHAdeMO (registered trademark) input terminals.

In the vehicle charge device 10, when the discharge voltage of the DC power supply 2a (battery) of the other vehicle 2 is the same as the charging voltage of the battery 1b of the own vehicle 1, a control unit (not illustrated) of the relay circuit 6 determines that there is no need to perform conversion by the voltage converter 5, so that the relay circuit 6 switches from the first switch 6a to the second switch 6b in accordance with an instruction from the control unit, and power can be directly supplied to the battery 1b from the DC input terminal 1a. In this way, since the relay circuit 6 can be switched depending on the type of the connected external power supply, the charging time can be shortened. Note that means for recognizing the discharge voltage of the DC power supply Za for instructing switching of the switch of the relay circuit 6 is not limited, and for example, the communication device 11 or the like described above may be used.

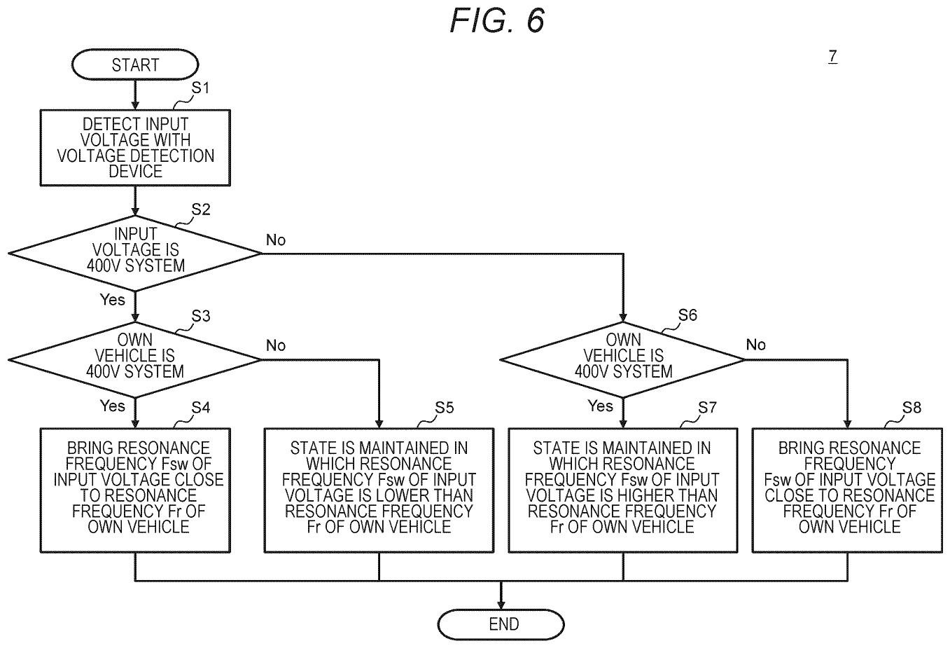

### (FIG. 6)

In step S1, the voltage conversion control unit 7 detects, with the voltage detection device 8, the DC voltage that is input. In step S2, it is determined whether the detected DC voltage is of a 400 V system. If yes, the process proceeds to step 83, otherwise the process proceeds to step S6. In step S3, it is determined whether the own vehicle 1 is of a 400 V system. If yes, the process proceeds to step S4, otherwise the process proceeds to step S5.

In step S4, since the voltage systems of the input voltage and the own vehicle 1 are the same (both input voltage and own vehicle 1 are 400 V system), the resonance frequency Fsw of the AC voltage converted in the process of transforming the DC voltage input by the voltage converter 5 is brought close to the resonance frequency Fr for making the AC voltage the charging voltage of the battery 1b.

In step S5, since it can be determined that the voltage systems of the input voltage and the own vehicle 1 are different, and the voltage system of the own vehicle 1 is higher than the voltage system of the input voltage (input voltage is 400 V system, and own vehicle 1 is 800 V system), a state is maintained in which the resonance frequency Fsw of the AC voltage converted in the process of transforming the DC voltage input by the voltage converter 5 is lower than the resonance frequency Fr for converting the DC voltage into the charging voltage of the battery 1b.

In step S6, it is determined whether the own vehicle 1 is of a 400 V system. If so, the process proceeds to step S7, otherwise the process proceeds to step S8. In step S7, it can be determined that the voltage systems of the input voltage and the own vehicle 1 are different, and the voltage system of the input voltage is higher than the voltage system of the own vehicle 1 (input voltage is 800 V system, and own vehicle 1 is 400 V system). Therefore, a state is maintained in which the resonance frequency Fsw of the AC voltage converted in the process of transforming the DC voltage input by the voltage converter 5 is higher than the resonance frequency Fr for converting the DC voltage into the charging voltage of the battery 1b.

In step S8, since the input voltage and the voltage system of the own vehicle 1 are the same (both input voltage and own vehicle 1 are 800 V system), the resonance frequency Fsw of the AC voltage converted in the process of transforming the DC voltage input by the voltage converter 5 is brought close to the resonance frequency Fr for making the AC voltage the charging voltage of the battery 1b.

According to the embodiment of the present invention described above, the following operational effects are obtained.
(1) A vehicle charge device 10 that charges a first battery 1b mounted on a first vehicle 1 includes: a power converter 4 that is connected to an AC power supply 3a outside the first vehicle 1 and converts AC power input from the AC power supply 3a into first DC power; a voltage converter 5 that transforms an input DC voltage into a charging voltage of the first battery 1b; a voltage conversion control unit 7 that controls the voltage converter 5; and a DC input terminal 1a connected to a DC power supply 28 outside the first vehicle 1. The DC input terminal 1a inputs a DC voltage of second DC power input from the DC power supply 2a to the voltage converter 5, and the voltage converter 5 transforms the DC voltage of at least one of the first DC power or the second DC power into a charging voltage of the first battery 1b according to an instruction from the voltage conversion control unit 7. In this way, it is possible to provide the vehicle charge device 10 that converts the discharge voltage of another vehicle into the charging voltage of the own vehicle in the inter-vehicle charging to realize charging.
(2) The vehicle charge device 10 further includes a voltage detection device 8 that detects the DC voltage of at least one of the first DC power or the second DC power input to the voltage converter 5, and the voltage conversion control unit 7 controls, on a basis of a value of the DC voltage detected by the voltage detection device 8 and the charging voltage of the first battery 1b, at least one of a frequency or a phase of an AC voltage converted in a process of transforming the DC voltage into the charging voltage of the first battery 1b in the voltage converter 5. With this configuration, the voltage converter 5 can be controlled according to the difference between the voltage of the DC power supply 2a (battery) of the other vehicle 2 and the charging voltage of the battery 1b of the own vehicle 1.
(3) The first vehicle 1 includes a communication device 11 that transmits and receives information on the first battery bl between the first vehicle 1 and a second vehicle 2 on which a second battery 2a is mounted and which is different from the first vehicle 1. The vehicle charge device 10 transmits and receives, via the communication device 11, information on the charging voltage of the first battery and information on the DC voltage that can be transformed by the voltage converter 5 into the charging voltage of the first battery. In this way, the vehicle on which the battery 2a having a discharge voltage close to the charging voltage of the battery 1b is mounted can be selected from the plurality of other vehicles 2 and charged.
(4) The DC input terminal 1a is a terminal that directly inputs the second DC power to the first battery 1b, and a rapid charging input terminal 13 for connection with the DC input terminal 1a is provided between the first battery 1b and the voltage converter 5. A relay circuit 6 including a first switch 6a that connects or disconnects the DC input terminal 1a and the voltage converter 5 and a second switch 6b that connects or disconnects the DC input terminal la and the rapid charging input terminal 13 is provided between the rapid charging input terminal 13 and the DC input terminal 1a and between the voltage converter 5 and the DC input terminal 1a. The relay circuit 6 disconnects the DC input terminal 1a and the voltage converter 5 and switches the first switch 6a and the second switch 6b so as to connect the DC input terminal 1a and the rapid charging input terminal 13 when a DC voltage of the second DC power is the same as a charging voltage of the first battery 1b. With this configuration, the relay circuit 6 can be switched depending on the type of the external power supply connected to the own vehicle 1.
(5) The DC input terminal 1a is connected to each of a plurality of second vehicles 2 on which a second battery 2a is mounted and which is different from the first vehicle 1, and the DC input terminal 1a inputs and outputs the second DC power between the first vehicle 1 and the plurality of second vehicles 2. In this way, power supply from two or more vehicles to the own vehicle 1 is enabled, and conversely, power supply from the own vehicle 1 to a plurality of other vehicles 2 is enabled.
(6) A vehicle charge system including the vehicle charge device 10 and the first battery 1b is adopted. With this configuration, charging can be realized by converting the discharge voltage of the other vehicle 2 into the charging voltage of the own vehicle 1 in the inter-vehicle charging.

Note that the present invention is not limited to the above embodiments, and various modifications and other configurations can be combined without departing from the gist of the present invention. In addition, the present invention is not limited to one including all the configurations described in the above embodiment, and includes one in which a part of the configuration is deleted.

### REFERENCE SIGNS LIST

1 own vehicle
1a DC input terminal
1b battery
2 other vehicle
2a DC power supply
3 AC charger
3a. AC power supply
4 power converter
4a EMC filter
4b PFC block
5 voltage converter
6 relay circuit
6a first switch
6b second switch
7 voltage conversion control unit
8 voltage detection device
10 vehicle charge device
11 control device
13 rapid charging input terminal
100 insulating transformer
105 choke coil (primary side switching circuit)
106 Common Mode Choke Coil
108 commercial AC power supply
206 choke coil (secondary side switching circuit)
402 voltage converter (tertiary side switching circuit)
403 capacitor
405 vehicle power supply socket
406 AC load
408 choke coil

1. A vehicle charge device that charges a first battery mounted on a first vehicle, the vehicle charge device comprising:
a power converter that is connected to an AC power supply outside the first vehicle and converts AC power input from the AC power supply into first DC power;
a voltage converter that transforms an input DC voltage into a charging voltage of the first battery;
a voltage conversion control unit that controls the voltage converter; and
a DC input terminal connected to a DC power supply outside the first vehicle,
wherein the DC input terminal inputs a DC voltage of second DC power input from the DC power supply to the voltage converter, and
wherein the voltage converter transforms the DC voltage of at least one of the first DC power or the second DC power into the charging voltage of the first battery according to an instruction from the voltage conversion control unit.

2. The vehicle charge device according to claim 1,
further comprising a voltage detection device that detects the DC voltage of at least one of the first DC power or the second DC power input to the voltage converter,
wherein the voltage conversion control unit controls, on a basis of the DC voltage detected by the voltage detection device and the charging voltage of the first battery, at least one of a frequency or a phase of an AC voltage converted in a process of transforming the DC voltage into the charging voltage of the first battery in the voltage converter.

3. The vehicle charge device according to claim 1,
wherein the first vehicle includes a communication device that transmits and receives information on the first battery between the first vehicle and a second vehicle on which a second battery is mounted and which is different from the first vehicle, and
wherein the vehicle charge device transmits and receives, to and from the second vehicle via the communication device, information on the charging voltage of the first battery and information on the DC voltage that can be transformed by the voltage converter into the charging voltage of the first battery.

4. The vehicle charge device according to claim 1,
wherein the DC input terminal is a terminal that directly inputs the second DC power to the first battery,
wherein a rapid charging input terminal for connection with the DC input terminal is provided between the first battery and the voltage converter,
wherein a relay circuit including a first switch that connects or disconnects the DC input terminal and the voltage converter and a second switch that connects or disconnects the DC input terminal and the rapid charging input terminal are provided between the rapid charging input terminal and the DC input terminal and between the voltage converter and the DC input terminal, and
wherein the relay circuit disconnects the DC input terminal and the voltage converter and switches the first switch and the second switch so as to connect the DC input terminal and the rapid charging input terminal when a DC voltage of the second DC power is the same as a charging voltage of the first battery.

5. The vehicle charge device according to claim 1,
wherein the DC input terminal is connected to each of a plurality of second vehicles on which a second battery is mounted and which is different from the first vehicle, and
wherein the DC input terminal inputs and outputs the second DC power between the first vehicle and the plurality of second vehicles.

6. A vehicle charge system comprising:
the vehicle charge device according to claim 1; and the first battery.
